(19) United States
(12) Patent Application Publication
(10) Pub. No.: US 2026/0058249 A1
(43) Pub. Date: Feb. 26, 2026

(54) Electrical Energy Storage Device for a Motor Vehicle, in Particular for a Motor Car

(71) Applicant: Bayerische Motoren Werke Aktiengesellschaft, Muenchen (DE)

(72) Inventors: Simon HAERLE, Muenchen (DE); Felix LAASCH, Muenchen (DE)

(21) Appl. No.: 19/104,108

(22) PCT Filed: Sep. 14, 2023
(86) PCT No.: PCT/EP2023/075245

§ 371 Date: Feb. 14, 2025

(30) Foreign Application Priority Data
Oct. 13, 2022 (DE) 10 2022 126 656.7

(51) Int. Cl. H01M 10/6557; H01M 10/613; H01M 10/615; H01M 10/617; H01M 10/625; H01M 10/63

(52) U.S. Cl. CPC H01M 10/6557; H01M 10/613; H01M 10/615; H01M 10/617; H01M 10/625; H01M 10/63

(57) ABSTRACT

An electrical energy storage device includes storage cells and a plurality of temperature control elements through which a temperature control medium flows and by which the temperature of the storage cells can be controlled. A distribution element is common to the temperature control elements and through which the temperature control medium flows and into which associated connection pieces of the temperature control elements are inserted so that the temperature control elements are fluidically connected to the distribution element. The distribution element has a distribution channel common to the temperature control elements and through which the temperature control medium flows. For each temperature control element, the distribution element comprises at least one through-flow opening through which the temperature control medium flows and into which the associated connection piece of the associated temperature control element is inserted, and the associated connection piece projects at least partially into the distribution channel.

### BACKGROUND AND SUMMARY

The invention relates to an electrical energy storage device for a motor vehicle, in particular for a motor car, according to the present disclosure.

A known battery module is identifiable from EP 2795713 B1, comprising a battery module housing having plastic parts and a plurality of prismatic battery cells which comprise a cell housing having four sidewalls. Moreover, JP 2018/536133 A1 discloses a cooling system.

An object of the present invention is the provision of an electrical energy storage device for a motor vehicle which enables the execution of a particularly advantageous temperature control, i.e. cooling and/or heating, in a particularly advantageous manner.

According to the invention, this object is fulfilled by an electrical energy storage device having the features disclosed herein. Advantageous configurations of the invention are also disclosed herein.

The invention relates to an electrical energy storage device for a motor vehicle, also simply described as a vehicle, which is preferably configured as a motor car, in particular as a passenger car. This means that, in its finished production state, the motor vehicle, also simply described as a vehicle, which is preferably configured as a motor car, in particular as a passenger car, comprises the electrical energy storage device. By the electrical energy storage device, electrical energy is storable or stored, in particular electrochemically. To this end, the electrical energy storage device comprises storage cells in which, or by which electrical energy is stored, in particular electrochemically. In particular, the storage cells are electrically interconnected. The storage cells are individual cells, and are thus mutually separately configured components. The electrical energy storage device is a high-voltage component, the electric voltage of which, in particular the electric service or rated voltage of which is preferably greater than 50 volts, in particular greater than 60 volts and, particularly preferably, is several hundred volts. In its finished production state, the motor vehicle also comprises at least one electric machine, by which the motor vehicle can be-in particular exclusively-electrically propelled. To this end, the electric machine can be supplied with electrical energy which is stored in the energy storage device. Particularly preferably, the electric machine is a high-voltage component, the electric voltage of which, in particular the electric service or rated voltage of which preferably greater than 50 volts, in particular greater than 60 volts and, particularly preferably, is several hundred volts. More particularly, the electrical energy store is a battery, which is also described as a secondary battery or is configured as a secondary battery which, in particular, can be configured as a high-voltage battery (HV battery). Accordingly, the storage cells are preferably battery cells, or the storage cells are also described as battery cells.

For example, the storage cells can be configured as round cells, which are cylindrically configured at their outer circumferential side, and thus assume the form of a right circular cylinder. Naturally, the preceding and following explanations are also applicable to other storage cells such as, for example, storage cells which are prismatic at their outer circumferential side.

The electrical energy storage device also comprises a plurality of temperature control elements through which a preferably fluid temperature control medium can flow, and by which the storage cells are temperature-controlled, i.e. cooled and/or heated, by the temperature control medium. In particular, the temperature control medium is a fluid which, for example, can at least comprise or contain water. In particular, in the event that the temperature control medium assumes a higher temperature than the storage cells, the temperature control medium is, or functions as a heating agent, by which the storage cells undergo heat-up. To this end, a heat transfer is executed from the temperature control medium, via the temperature control elements, to the storage cells. In particular, in the event that the temperature control medium assumes a lower temperature than the storage cells, the temperature control medium is, or functions as a coolant, by which the storage cells are cooled. To this end, a heat transfer is executed from the storage cells, via the respective temperature control element, to or into the temperature control medium.

In particular, the temperature control elements are configured in a mutually separate manner, and are thus mutually separately configured individual components. In particular, the temperature control elements are at least partially fluidically separated from one another. In particular, this can be understood as follows: the respective temperature control element, for example, comprises at least one, or exactly one temperature control channel, through which the temperature control medium can flow. For example, the respective temperature control channel is delimited, in particular directly, by a respective inner circumferential shell surface of the respective temperature control element. The temperature control channels are at least partially fluidically separated from one another. Thus, for example, a respective sub-volume or a respective sub-stream of the temperature control medium can flow through the respective temperature control channel, and thus through the respective temperature control element wherein, in particular, it is provided that the sub-volumes or sub-streams, as they flow through the temperature control element, and thus through the temperature control channel, are not mutually combined. Expressed in different terms, for example, the sub-volumes or sub-streams flow separately through the temperature control channels, and thus through the temperature control elements.

In order to enable the execution of a particularly advantageous temperature control in a particularly advantageous manner, according to the invention, it is provided that the electrical energy storage device comprises a distribution element, which is common to the temperature control elements and through which the temperature control medium can flow, and into which respective connection pieces of the temperature control elements are inserted. As a result, the temperature control elements, and thus the temperature control channels thereof, are fluidically connected to the distribution element. Accordingly, the temperature control elements, by the distribution element, can be supplied with temperature control medium from the distribution element, which flows through the distribution element. In other words, for example, the temperature control medium flowing through the distribution element, via the connection pieces, can be discharged from the distribution element and admitted to the respective temperature control elements, in order to supply the temperature control elements with the temperature control medium.

It is further conceivable that, by the fluidic connection of the temperature control elements, and thus of the temperature control channels thereof, with the distribution element, the temperature control medium flowing through the temperature control elements is discharged from the temperature control elements and, in particular, is admitted to the distribution element. In other words, for example, the temperature control medium flowing through the temperature control elements can be discharged from the temperature control elements via the connection pieces, and admitted to the distribution element.

In particular, the temperature control element comprises a distribution channel through which the temperature control medium can flow, and which is common to the temperature control elements, which is a common distribution channel to the temperature control channels. In the direction of flow of the temperature control medium which flows through the distribution element, and thus through the distribution channel, and through the temperature control elements, and thus through the temperature control ducts, and which is admitted from the distribution element, and thus from the distribution channel, into the temperature control elements, and thus into the temperature control channels, the distribution channel is arranged upstream of the temperature control channels, such that the temperature control medium, on its path towards and into the temperature control elements, firstly flows through the distribution channel, then through the temperature control channels, and thus flows through the temperature control elements. The above-mentioned sub-volumes or sub-streams can flow through the temperature control channels. For example, the sub-volumes or sub-streams, in combination, form or constitute an overall volume or overall stream of the temperature control medium, which overall volume or overall stream flows through the distribution channel, and thus through the distribution element. In other words, on its path towards and into the temperature control elements, and thus towards and into the temperature control channels, the overall stream or overall volume firstly flows through the distribution channel, and thus through the distribution element. The overall stream is subdivided into sub-streams, i.e. is distributed over the sub-streams, and thus over the connection pieces and the temperature control elements, such that the respective sub-stream flows through the respective connection pieces, and thus through the respective temperature control element. In particular, once the sub-streams, for example, have flowed through the temperature control elements, the sub-streams, for example, are recombined and, in particular, are merged, as a result of which, for example, the sub-streams again for the overall stream but, in this case, downstream of the temperature control elements.

As the respective connection pieces, also simply described simply as nozzles, are at least partially inserted into the distribution element, even substantial tolerances, in particular positional tolerances, between the individual temperature control elements and/or between the respective individual temperature control element and the distribution element can be offset, such that the electrical energy storage device can be assembled, i.e. produced, in a particularly simple, and thus in a time-efficient and cost-effective manner. In the context of a production of the energy storage device, for example, the connection pieces are arranged to project directly into the distribution element, in particular wherein the connection pieces are inserted, in particular directly, into the distribution element, and the insertion thereof is executed accordingly. In particular, by the invention, a particularly space-saving design can be achieved.

In particular, it is provided that the temperature control elements are configured in a mutually separate manner. Moreover, the temperature control elements are configured separately from the distribution element, such that the connection pieces are configured separately from one another, and separately from the distribution element. The respective connection piece, which is separately configured from the distribution element, is inserted, in particular directly, into the distribution element, as a result of which a particularly simple, and thus time-efficiently and cost-effectively achievable production or assembly of the electrical energy storage device can be provided.

In particular, by the invention, and particularly by the advantageous tolerance equalization, an automated installation of connection pieces wherein, for example, the latter are inserted in the distribution element in an automated manner, can be provided.

If, for example, the temperature control elements are supplied with temperature control medium from the distribution element via the connection pieces, for example, the temperature control medium, on its path through the distribution element to the connection pieces, flows along or in a first direction of flow through the distribution element, in particular through the distribution channel. The distribution element or distribution channel, in the direction of flow of the temperature control medium, i.e. considered along the first direction of flow, is thus arranged upstream of the temperature control elements. However, in the event that, for example, the temperature control medium is discharged, i.e. released from the temperature control elements via the connection pieces, and is admitted to the distribution element, in particular to the distribution channel, the temperature control medium thus flows along or in a second direction of flow through the distribution element, in particular through the distribution channel. The distribution element or distribution channel, in the direction of flow of the temperature control medium, i.e. considered along the second direction of flow, is thus arranged downstream of the temperature control elements. The delivery of temperature control medium to the temperature control elements from the distribution channel is also described as supplying the temperature control elements. The discharge of temperature control medium from the temperature control elements via the connection pieces into the distribution element, in particular into the distribution channel, is also described as evacuating or an evacuation of the temperature control elements.

It is moreover provided, according to the invention, that the connection element of the distribution channel, which is common to the temperature control elements and through which the temperature control medium can flow, for each temperature control element, comprises at least one or exactly one through-flow opening, through which temperature control medium can flow from the distribution channel. If the distribution element is employed for supplying the temperature control elements, the respective through-flow opening, through which the temperature control medium can flow, is an outlet opening which, in the direction of flow of the temperature control medium, i.e. considered along the first direction of flow, is arranged downstream of the distribution channel. If the distribution element is employed for evacuating the temperature control elements, the respective through-flow opening, through which the temperature control medium can flow, in the direction of flow of the temperature control medium, i.e. considered along the second direction of flow, is arranged upstream of the distribution channel.

The respective connection piece of the respective temperature control element is inserted into the respective through-flow opening. For the supply of temperature control elements, via the respective through-flow opening, the temperature control medium can be discharged from the distribution channel and introduced, i.e. admitted to the respective temperature control element, in particular to the respective temperature control channel. For the evacuation of temperature control elements, via the respective through-flow opening, the temperature control medium can be discharged from the respective temperature control element, in particular from the respective temperature control channel, and admitted to the distribution element, in particular to the distribution channel.

The through-flow openings are preferably mutually separated. Hereby, it is to be understood that, between the through-flow openings, respective wall regions of the distribution element which, in particular, are configured as solid bodies, are arranged. For example, the through-openings are configured with a circular design. In this embodiment, a particularly advantageous assembly of the electrical energy store can be achieved.

In order to permit the fitting of temperature control elements to the distribution element, and thus to the energy storage device as a whole, in a particularly advantageous manner, it is moreover provided that the respective connection pieces project at least partially into the distribution channel. In other words, it is preferably provided that the respective commection piece, in particular in the longitudinal direction of extension thereof, is inserted into the through-flow opening, and thus into the distribution element, to an extent or depth such that the respective connection piece projects at least partially into the distribution channel. Thus, in particular, it is conceivable that the connection piece, on a first side of the through-flow opening, which is arranged in the distribution channel, projects from the through-flow opening, and thus projects into the distribution element and, in particular, into the distribution channel and, for example, on a second side of the through-flow opening, which is arranged opposite the first side, the connection piece projects from the through-flow opening and, in particular, from the distribution element, and is thus arranged in an environment of the distribution element, as a result of which a particularly advantageous assembly can be provided.

A further embodiment is characterized in that the respective connection piece engages to the rear of a respective wall region of the distribution element, which is arranged in the distribution channel, as a result of which the respective connection piece is retained on the distribution element, and is thus mechanically connected to the distribution element. As a result, a particularly advantageous assembly can be achieved, particularly wherein the respective connection piece is inserted into the respective through-flow opening to an extent or depth such that the respective connection piece engages with the respective wall region from the rear, and is thus latched to the rear thereof. As a result, in a particularly simple, and thus in a time-efficient and cost-effective manner, a particularly secure mechanical retention of the respective connection piece on the distribution element can be ensured.

In a further particularly advantageous embodiment of the invention, it is provided that the respective connection piece, at the respective end thereof which faces the distribution channel, in particular the free end thereof, comprises a respective lead-in chamfer, which is oriented obliquely to a plug-in direction, in which the respective connection piece is plugged into the respective through-flow opening. For example, the respective lead-in chamfer extends in a respective plane, which is oriented obliquely to the plug-in direction or, for example, the lead-in chamfer is configured with a conical design. As a result, the respective connection piece can be plugged into the respective through-flow opening in a particularly simple manner, such that a particularly simple, and thus a time-efficient and cost-effective assembly can be provided.

In order to enable a particularly advantageous offsetting of tolerances and, in consequence, a particularly advantageous assembly, according to a further configuration of the invention, it is provided that the respective through-flow opening is configured in a respective first longitudinal region of the distribution element. Considered along a direction of extension of the distribution element which, for example, is configured as a longitudinal direction of extension, a respective second longitudinal region of the distribution element is arranged between two respective first longitudinal regions. The respective second longitudinal region is configured as elastically deformable along the direction of extension. As a result, particularly considered along the direction of extension, tolerances, in particular positional tolerances or location tolerances, can be offset, i.e. compensated, in a particularly advantageous and simple manner.

In order to enable the offsetting, i.e. compensation of tolerances in a particularly advantageous and simple manner, according to a further configuration of the invention, it is provided that the respective second longitudinal region is configured in the form of a bellows.

In a further particularly advantageous configuration of the invention, it is provided that the respective first longitudinal region is formed of a first material, and that the respective second longitudinal region is formed of a second material which, in relation to the first material, is softer and/or more elastic. As a result, for example, a length of the distribution element along the direction of extension can be adjusted in a particularly advantageous manner, in particular with no resulting damage to the distribution element. As a result, tolerances can be offset in a particularly advantageous manner.

The first material and the second material, for example, are a respective plastic material. In particular, it is conceivable that the distribution element is produced by injection-molding, in particular by plastic injection-molding. Particularly preferably, the distribution element is configured as a two-component plastic part, in particular as a two-component injection-molded part, wherein the distribution element is also described as a 2C plastic part. In a production operation of the distribution element, for example, a first part of the distribution element is firstly produced, in particular by injection molding, whereafter, for example, a second part of the distribution element is molded onto the first part, in particular by injection molding. For example, the first part is produced from one of the plastics or from one of the materials, and the second part is produced from the other plastic or material. Thus, in the finished production state of the distribution element, the second part is molded onto the first part. For example, the first part is formed of the first material, and the second part is formed of the second material.

In order to enable an execution of a particularly advantageous temperature control in a particularly advantageous and simple manner, according to a further configuration of the invention, it is provided that the distribution element comprises at least one throttle element, by which a sub-region of a flow cross-section of at least one of the connection pieces through which the temperature control medium can flow is overlapped, and is thus fluidically obstructed. This means that one of the connection pieces, in particular in relation to at least one other of the connection pieces, is throttled. As a result, in particular during the supply and/or evacuation of the temperature control elements, a particularly advantageous division or distribution of temperature control medium over the temperature control elements can be achieved, such that an at least essentially uniform i.e. homogeneous temperature control of the storage cells is provided. In particular, it is conceivable that the one throttled connection piece, in the direction of flow of the temperature control medium which flows through the distribution channel, is arranged upstream of the other, in particular unthrottled or less substantially throttled connection pieces, in particular during supply, such that an essentially uniform temperature control can be provided. The throttle element is, or functions as a throttle, in order to enable the execution of an advantageous distribution or division of the temperature control medium over the connection pieces, and thus over the temperature control elements.

As the respective first longitudinal region is formed of the first material, an advantageous stability, i.e. rigidity or stiffness of the respective first longitudinal region can be achieved such that, for example, the respective connection piece can be inserted into the respective through-flow opening in a particularly advantageous manner. In particular, as a result, a particularly advantageous stability or robustness of the respective first longitudinal region in response to a radial pressure can be ensured such that, in particular, an automated assembly can be provided. In an automated assembly, for example, connection pieces are inserted into the through-flow openings in an automated manner, i.e. automatically, for example by a robot.

Finally, for the execution of a particularly advantageous temperature control, it has proved to be particularly advantageous if the distribution element comprises a first material and a second material which, in relation to the first material, is soffer and/or is elastically deformable. The second material can be the second raw material. Alternatively or additionally, the first material can be the first raw material. By the second material, the respective connection piece is sealed vis-à-vis the distribution element. As a result, for example, a pressure-supported seal can be achieved. It has proved to be advantageous if, as described above, the distribution element is configured as a two-component plastic part, which is produced by injection-molding, and is thus produced from the materials. For example, the second material and the first material are injection-molded. In particular, it is conceivable that the second material, in particular the connection pieces thereof, forms a respective sealing element which, for example, is configured as a sealing lip, by which the respective connection piece is sealed, in a particularly advantageous manner, vis-à-vis the distribution element.

It has further proved to be particularly advantageous if the respective connection piece comprises a respective step, for example in order to prevent any unintentional release or separation from distribution element and/or to accommodate separating forces associated with a fluid pressure, in particular of the temperature control medium.

Further details of the invention proceed from the following description of preferred exemplary embodiments, together with the associated drawings.

### BRIEF DESCRIPTION OF THE DRAWINGS

FIG. 1 shows a partial representation of a schematic sectional view of an electrical energy storage device for a motor vehicle, according to a first embodiment;

FIG. 2 shows a partial representation of a finther schematic sectional view of the electrical energy storage device according to the first embodiment; and

FIG. 3 shows a partial representation of a schematic sectional view of a second embodiment of the electrical energy storage device.

### DETAILED DESCRIPTION OF THE DRAWINGS

In the figures, identical or functionally equivalent elements are identified by the same reference symbols.

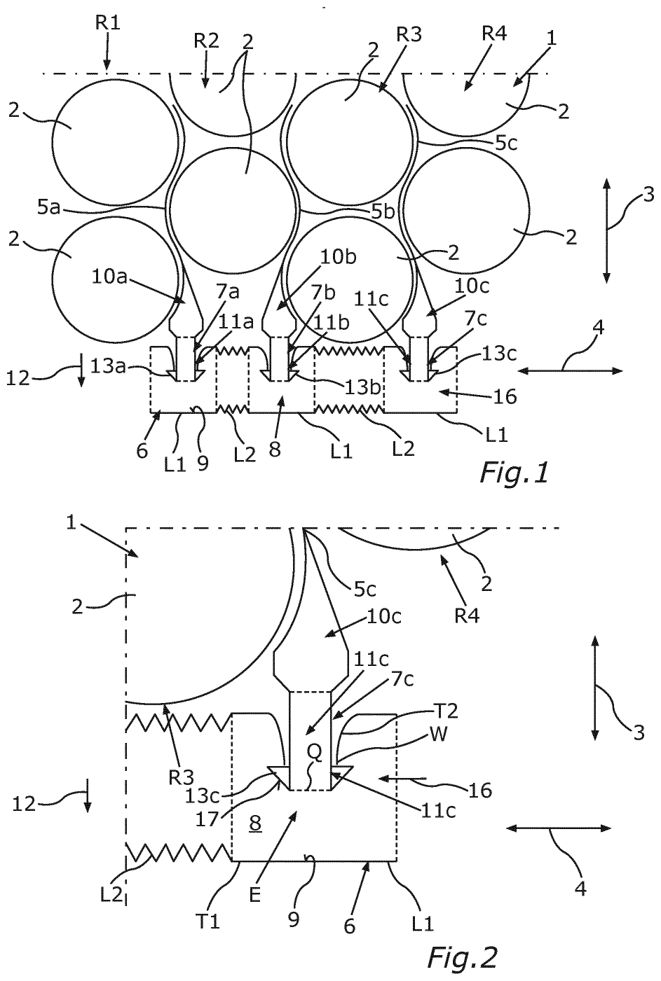

FIGS. 1 and 2 respectively show a partial representation of a schematic sectional view of a first embodiment of an electrical energy storage device 1, which is also simply described as an energy storage device, for a motor vehicle, which is also simply described as a vehicle. The electrical energy storage device 1 comprises a plurality of storage cells 2 which, in the exemplary embodiment according to the figures, are configured as round cells. It can be seen that the storage cells 2 are arranged in rows such that, in the present case, the first storage cells 2 form a first cell row R1, the second storage cells 2 form a second cell row R2, the third storage cells 2 form a third cell row R3, and the fourth storage cells 2 form a fourth cell row R4. The respective storage cells 2 which form the respective cell rows R1-4 are arranged sequentially, i.e. one after another, along a first direction which is indicated by a double-headed arrow 3, wherein the cell rows R1-4 are arranged next to one another, and thus sequentially, along a second direction which is perpendicular to the first direction and which is indicated by a double-headed arrow 4.

The electrical energy storage device 1 also comprises a plurality of temperature control elements 5a-c. It can be seen that, in the present case, the temperature control elements 5a-c are arranged sequentially along the second direction (according to the double-headed arrow 4), such that the temperature control element 5a is arranged along the second direction between cell rows R1 and R2, the temperature control element 5b is arranged along the second direction between cell rows R2 and R3, and the temperature control element 5c is arranged along the second direction between cell rows R3 and R4. A preferably fluid temperature control medium, which is thus preferably configured as a fluid, can flow through the respective temperature control element 5a-c, wherein the temperature control medium can be a constituent of the energy storage device 1. It can be seen that the respective temperature control element 5a-c, considered in a plane which is described by the first direction and the second direction, is configured with an undulating design. As a result, the temperature control element 5a-c, in a particularly advantageous manner, can be close-fitted to the respective storage cell 2, particularly in an exceptionally flush-fitted arrangement, such that a particularly advantageous temperature control, i.e. cooling and/or heating of the respective storage cell 2 can be provided via the respective temperature control element 5a-c, by the respective temperature control medium which flows through the respective temperature control element 5a-c. In particular, the temperature control elements 5a-c are arranged in a temperature control circuit of the electrical energy storage device 1 through which the temperature control medium flows. The temperature control elements 5a-c are configured separately from the storage cells 2, and separately from one another.

In order to enable, in a particularly advantageous manner, the execution of a particularly advantageous temperature control of the storage cells 2, the energy storage device 1 comprises a distribution element 6 which is common to the temperature control elements 5a-c, and which is configured separately from the storage cells 2 and separately from the temperature control elements 5a-c, and which is also described as a distribution pipe or is configured as a distribution pipe.

The distribution element 6 is a distribution element which is common to the temperature control elements 5a-c and through which the preferably fluid temperature control medium can flow, into which respective connection pieces 7a-c of the respective temperature control elements 5a-c are inserted. As a result, the temperature control elements 5a-c are at least fluidically connected to the distribution element 6 such that the temperature control medium which firstly flows through the distribution element 6 flows into the connection pieces 7a-c, and thus flows out of the distribution element 6, is admitted to the temperature control elements 5a-c and, in consequence, can flow through the temperature control elements 5a-c. Accordingly, the temperature control elements 5a-c, by the distribution element 6, can be supplied with temperature control medium which flows through the distribution element 6 and out of the distribution element 6. In the exemplary embodiment represented in the figures, the distribution element 6 can thus be employed for supplying the temperature control elements 5a-c with the temperature control medium.

It can be seen that the distribution element 6, in particular in its interior, comprises a distribution channel 8 which, more particularly, is delimited by an inner circumferential shell surface 9 of the distribution element 6, in particular directly. The respective temperature control element 5a-c comprises a respective temperature control channel 10a-c, through which the respective temperature control medium which flows through the respective connection piece 7a-c can flow. The respective connection piece 7a-c is inserted in a respectively assigned through-flow opening of the distribution element 6 which, in the present case, is configured as an outlet opening 11a-c, wherein the respective connection piece 7a-c is inserted into outlet opening 11a-c of the distribution element 6 which is respectively assigned thereto, in particular along a plug-in direction, as indicated in FIG. 1 by an arrow 12. The plug-in direction is oriented in, or parallel to the plane which is described by the first direction and the second direction. For example, the plug-in direction is oriented parallel to the first direction (according to the double-headed arrow 3).

The respective connection piece 7a-c is inserted along the plug-in direction into the respective outlet opening 11a-c to an extent or depth such that the respective connection piece 7a-c projects at least partially into the distribution channel 8, and is thus arranged in the distribution channel 8. This can be seen particularly clearly from FIG. 2.

It can be seen particularly clearly from FIG. 2 that the respective connection piece 7a-c engages to the rear of a respective wall region W of the distribution element 6, which is arranged in the distribution channel 8, particularly considered along the plug-in direction. As a result, the respective connection piece 7a-c is also mechanically connected to the distribution element 6, and is thus retained on the distribution element 6. To this end, the respective connection piece 7a-c comprises a respective collar 13a-c, which engages to the rear, and is thus latched to the rear of the respective wall region W. Moreover, the respective connection piece 7a-c, at the respective and, in particular, the free end thereof E which faces the distribution channel 8, comprises a, for example, conically-shaped lead-in chamfer 14, which is oriented obliquely to the plug-in direction. In the present case, the respective lead-in chamfer 14 is formed by the respective collar 13a-c. Upon the insertion of the respective connection piece 7a-c into the distribution element 6, in particular into the respective outlet opening 11a-c, the lead-in chamfer 13a-c advantageously slides over the distribution element 6, as a result of which the respective connection piece 7a-c can be inserted into the distribution element 6 in a particularly simple, and thus in a time-efficient and cost-effective manner.

The respective outlet opening 11a-c is configured in a respective first longitudinal region L1 of the distribution element 6. Along a direction of extension of the distribution element 6, which is indicated by the double-headed arrow 4 and which, in the present case, is configured as a longitudinal direction of extension, which is longitudinally configured along the direction of extension, a respective second longitudinal region L2 of the distribution element 6 is respectively arranged between two of the respective first longitudinal regions L1 of the distribution element 6. The respective second longitudinal region L2 is configured to be elastically deformable along the direction of extension which is indicated by the double-headed arrow 4, in the present case, for example, such that the respective second longitudinal region L2 is configured in the form of a bellows. In the present case, it is additionally provided that at least a first part T1 of the respective first longitudinal region L1 is formed of a first raw material, which is also described as a first material. The respective second longitudinal region L2 is formed of a second raw material, which is also described as a second material. The second material is softer than the first material, such that second material is more elastically deformable than the first material. A respective second part T2 of the respective first longitudinal region L1 is formed of the first material wherein, according to the first embodiment, it is provided that the respective outlet opening 11a-c is delimited, in particular directly, by the second material. As a result, the respective second part T2 of the respective first longitudinal region L1 is or forms a respective sealing element which, in a particularly advantageous manner, can be close-fitted to the respective connection piece 7a-c, in particular at a respective outer circumferential shell surface 14 of the respective connection piece 7a-c, such that the respective connection piece 7a-c, by the respective second part T2, is sealed vis-à-vis the distribution element 6 in a particularly advantageous manner.

The parts T1 and T2, and the longitudinal regions L1 and L2, are preferably configured in a mutually integral arrangement. It is preferably provided that the first material and the second material respectively are plastic materials. In other words, the first material can be a first plastic, and the second material can be a second plastic. It is thus conceivable that the distribution element 6 is configured as a two-component plastic part, wherein the distribution element 6, in particular, is produced by injection-molding. Accordingly, during the production of the distribution element 6, for example, the materials are molded onto one another, in particular such that the second material and the first material are injection-molded. As a result, a simple, and thus a time-efficient and cost-effective production of the distribution element 6 can be achieved.

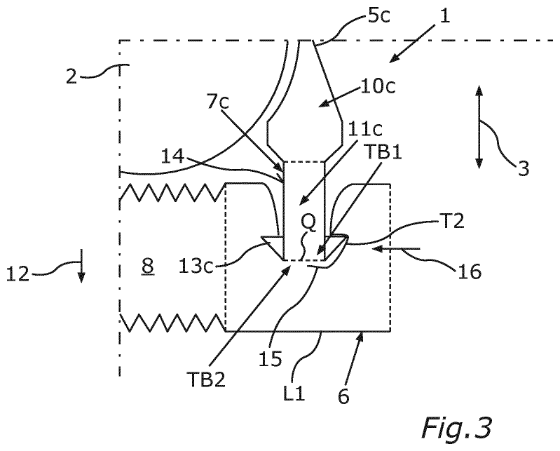

FIG. 3 shows a partial representation of a schematic sectional view of a second embodiment of the energy storage device 1. In the second embodiment, the distribution element 6 comprises at least one throttle element 15. In the second embodiment, the throttle element 15 is formed by the second part T2 of one of the longitudinal regions L1, such that the throttle element 15 is formed of the second material. From FIG. 3, it can be seen that the throttle element 15 overlaps, and thus fluidically obstructs a first sub-region TB1 of a flow cross-section Q of the connection piece 7c through which the temperature control medium can flow, wherein a second sub-region TB2 of the flow cross-section Q which, in particular, directly adjoins the first sub-region TB1, is released, and thus enables a through-flow of the temperature control medium therein.

In FIG. 3, an arrow 16 indicates a direction of flow along which the temperature control medium flows on its path through the distribution element 6 to the connection pieces 7a-c, through the distribution channel 8, and thus through the distribution element 6. In relation to this direction of flow, the outlet openings 11a-c are arranged downstream of the distribution channel 8. It can be seen that, in relation to the direction of flow of the temperature control medium indicated by the arrow 16, the connection piece 7c, the flow cross-section Q of which is partially obstructed, and is thus throttled, by the throttle element 15 is arranged upstream of the other connection pieces 7a and 7b, the flow cross-sections Q of which, for example, are not throttled, or are less substantially throttled than the flow cross-section Q of the connection piece 7c. As a result, an at least essentially uniform distribution or division of the temperature control medium from the distribution channel 8 onto or into the connection pieces 7a-c, and thus onto or into the temperature control elements 5a-c can be achieved, such that an least essentially uniform, and thus homogeneous temperature control of the storage cells 2, in particular of the cell rows R1-4, can be provided.

### LIST OF REFERENCE SYMBOLS

1 Electrical energy store
2 Storage cell
3 Double-headed arrow
4 Double-headed arrow
5a-c Temperature control element
6 Distribution element
7a-c Connection piece
8 Distribution channel
9 Inner circumferential shell surface
10a-c Temperature control channel
11a-c Outlet opening
12 Arrow
13a-c Collar
14 Outer circumferential shell surface
15 Throttle element
16 Arrow
E End
L1 First longitudinal region
L2 Second longitudinal region
Q Flow cross-section
R1-4 Cell rows
T1 First part
T2 Second part
TB1 First sub-region
TB2 Second sub-region

1-8. (canceled)

9. An electrical energy storage device for a motor vehicle, comprising:
a plurality of storage cells configured to store electrical energy;
a plurality of temperature control elements configured such that a temperature control medium flows therethrough, by which the storage cells are temperature controlled by the temperature control medium,
a distribution element which is common to the plurality of temperature control elements and through which the temperature control medium flows, into which, respective connection pieces of the temperature control elements are inserted, wherein the temperature control elements are fluidically connected to the distribution element via the connection pieces, wherein the distribution element comprises:
a distribution channel that is common to the temperature control elements and through which the temperature control medium flows; and
for each temperature control element, at least one through-flow opening through which the temperature control medium flows, into which the respective connection piece of the respective temperature control element is inserted, and wherein the respective connection piece at least partially projects into the distribution channel.

10. The electrical energy storage device according to claim 9,
wherein the respective connection piece engages to a rear of a respective wall region of the distribution element, which is arranged in the distribution channel, a result of which the respective connection piece is retained on the distribution element.

11. The electrical energy storage device according to claim 9,
wherein the respective connection piece, at a respective end thereof that faces the distribution channel, comprises a respective lead-in chamfer that is oriented obliquely to a plug-in direction, in which the respective connection piece is plugged into the respective through-flow opening.

12. The electrical energy storage device according to claim 9,
wherein the respective through-flow opening is arranged in a respective first longitudinal region of the distribution element wherein, considered along a direction of extension of the distribution element, a respective second longitudinal region of the distribution element is arranged between two respective first longitudinal regions, the respective second longitudinal region of which is configured as elastically deformable along the direction of extension.

13. The electrical energy storage device according to claim 12.
wherein the respective second longitudinal region is configured in a form of a bellows.

14. The electrical energy storage device according to claim 12,
wherein the respective first longitudinal region is at least partially formed of a first material, and the respective second longitudinal region is at least partially formed of a second material which, in relation to the first material, is soffer and/or more elastic.

15. The electrical energy storage device according to claim 9,
wherein the distribution element comprises at least one throttle element, by which a sub-region of a flow cross-section of at least one of the connection pieces through which the temperature control medium flows is overlapped, and is thus fluidically obstructed.

16. The electrical energy storage device according to claim 9,
wherein the distribution element comprises a first material and a second material that is softer and/or more elastically deformable in relation to the first material, by which the respective connection piece is sealed vis-à-vis the distribution element.
